(19) United States
(12) Patent Application Publication
(10) Pub. No.: US 2024/0262057 A1
(43) Pub. Date: Aug. 8, 2024

(54) ADAPTER FOR A DEVICE SEALING PNEUMATIC TIRES BY MEANS OF A SEALING LIQUID, SYSTEM COMPRISING ADAPTER AND SEALING LIQUID CONTAINER AND DEVICE FOR SEALING PNEUMATIC TIRES BY MEANS OF A SEALING LIQUID

(71) Applicant: Aircom Automotive Sp. z o.o. Sp. k., PIETRZYKOWICE (PL)

(72) Inventor: Dominik Gschwender, Steckborn (CH)

(21) Appl. No.: 18/692,277

(22) PCT Filed: Sep. 16, 2022
(86) PCT No.: PCT/EP2022/075795

§ 371 Date: Mar. 14, 2024

(30) Foreign Application Priority Data
Sep. 17, 2021 (DE) 10 2021 124 116.2

(51) Int. Cl. B29C 73/16

(52) U.S. Cl. CPC B29C 73/166

(57) ABSTRACT

The invention relates to an adapter (30) for a device (1) for sealing pneumatic tires by means of a sealing liquid, wherein the adapter (30) has a first fluid coupling section (31) which is configured for fluidically coupling the adapter (30) to a compressor (10) of the device (1), and wherein the adapter (30) has a second fluid coupling section (33) which is fluidically coupled to the first fluid coupling section (31) and is configured to fluidically couple the adapter (30) to an air inlet opening of a sealing liquid container (20) of the device (1), wherein the adapter (30) is designed as a base for the sealing liquid container (20).

The invention relates to an adapter for a device for sealing pneumatic tires by means of a sealing liquid, wherein the adapter has a first fluid coupling section which is configured for fluidically coupling the adapter to a compressor of the device, and wherein the adapter has a second fluid coupling section which is fluidically coupled to the first fluid coupling section and configured to fluidically couple the adapter to an air inlet opening of a sealing liquid container of the device. The invention further relates to a system consisting of the adapter and the sealing liquid container and the device for sealing pneumatic tires by means of a sealing liquid.

Tire sealants have been used in pneumatic tires for a long time since the use of spare tires no longer appears to be as profitable and expedient as it used to be, for reasons of space but also due to the infrequent damage to tires. These tire sealants are normally intended for the short-term repair of tire emergencies where a hole, a tear or, generally speaking, an opening occurs in a tread and wall of a tire. Conventional tire sealants are based on a latex-rubber base substance. They form a rubber-like mass in the tire. The tire sealant is inserted through the tire valve and temporarily closes the hole or opening. The tire is then replaced later.

Substantially two systems are known for the application, namely, on the one hand, a “standard system” in which a sealing liquid can be provided in a compressible container, such as a compressible plastic bottle or a bag, and the sealing liquid is manually pressed into the tire by compressing the compressible container. The sealing is then carried out both mechanically by “plugging” and by coagulation in the opening, with the assistance of a chemical reaction of the sealing liquid. The container is connected to the tire valve via a hose. Subsequent inflation of the tire and the rotating and flexing movement while driving further strengthen the sealing effect.

On the other hand, so-called “convenience systems” are known, to which the present invention also belongs and in which the sealing liquid container is connected to a compressor, which can, for example, be operated via a connection in the vehicle. The sealing liquid is then carried along by the air flow and brought to the damaged part. The sealing then takes place as described.

A kit for repairing and inflating inflatable articles is known from EP2029348B1. In this case, a compressor assembly is fluidically and mechanically connected by means of a click-on connection means to a container assembly containing sealing liquid. The click-on connection means can be regarded as an adapter according to the preamble of claim 1. Such an adapter is complex to produce and correspondingly cost-intensive. Furthermore, when producing the fluidic and mechanical connection between the compressor assembly and the container assembly, the click-on connection means can easily be damaged, for example break. The kit can then no longer be used or can at least no longer be used in a correct and operationally reliable manner.

The object of the invention is to provide an adapter and a corresponding system of a device for sealing pneumatic tires by means of a sealing liquid as well as the device which avoid the mentioned problems and in particular enable a simple-to-produce and operationally reliable fluidical and mechanical connection between the compressor and the sealing liquid container.

On the one hand, this object is achieved by an adapter having the features of claim 1. Accordingly, the adapter is designed according to the type mentioned at the outset and is designed as a base for the sealing liquid container. Designed as a base, the adapter can be set up separately from the compressor on a surface. The adapter can be coupled to the sealing liquid container, and in particular the sealing liquid container can be placed on the adapter. The sealing liquid container can preferably be locked on the adapter by means of a bayonet lock, as will be explained in more detail later.

The compressor can be arranged in a compressor housing.

It can be provided that the adapter is not connected to or arranged in a common housing with the compressor, but is designed separately and independently of the compressor.

In particular, it can be provided according to one embodiment that the adapter is neither connected to the compressor via a force-fitting connection nor via a form-fitting connection, but it can be set up separately and independently on the surface. The adapter is therefore preferably independent of the compressor or a compressor housing.

In particular, the adapter offers the advantage that sealing liquid containers which can be placed on the adapter can be coupled in this way to any compressors, so that this solution is also advantageous in particular as a retrofitting solution or refilling solution in which the sealing liquid container of a manufacturer can be offered together with the adapter, and can also be coupled to existing compressors of other manufacturers or other connection or coupling sections.

In particular, an air hose can be used to establish the fluid connection between the sealing liquid container and the compressor. For this purpose, the air hose can connect the first fluid coupling section of the adapter to the compressor. A complex attachment of the sealing liquid container to the compressor, which is expensive to produce and susceptible to damage, is thereby avoided. Instead, an uncomplicated solution can be provided in which the sealing liquid container can be configured separately from the compressor and can be fluidically coupled to the compressor in a technically simple, operationally reliable and inexpensive manner by means of the air hose.

It can be provided that the first fluid coupling section has a first fastening section which is configured to fasten an air hose for fluidically coupling the adapter to the compressor. The air hose can thereby be securely secured to the first fluid coupling section. The first fastening section can be a mechanical fastening section. For example, the first fastening section can be designed in the form of an external thread. The external thread can be arranged on the first fluid coupling section designed as a first tube. The external thread can be designed to correspond to an internal thread of a first fluid coupling end piece of the air hose. The first fluid coupling end piece can furthermore have an actuating section for producing the teeth between the external thread and the internal thread.

It can also be provided that a second fastening section is arranged on the second fluid coupling section and is configured to fasten the sealing liquid container to the adapter. The second fastening section serves in particular to fasten the sealing liquid container to the adapter.

In this case, it can be provided that the second fastening section is configured to be coupled by a rotational movement of the sealing liquid container in a first direction of rotation relative to the adapter with a third fastening section of the sealing liquid container. The second fastening section can be designed to form the bayonet lock already mentioned above with the third fastening section. A bayonet lock is understood to be a mechanical connection that can be produced and released between the second fastening section and the third fastening section.

Furthermore, it can be provided that the second fastening section has at least one first fastening element which is configured to engage in at least one first recess of the third fastening section by a placement movement or (plugging on) movement of the sealing liquid container on the adapter and to be brought into engagement with at least one second recess of the third fastening section by a rotary movement of the sealing liquid container in the first direction of rotation. The at least one first fastening element can be a bayonet element projecting from a cylindrical part of the second fastening section. The at least one first recess can be a groove, in particular running in the longitudinal direction of the second fastening section. The at least one second recess can be an elongated hole running in the circumferential direction. The third fastening section can in particular be designed as a neck of the sealing liquid container. In this respect, the neck can also be referred to as a bottleneck if the sealing liquid container is alternatively referred to as a sealing liquid bottle. The fastening sections for the bayonet lock are therefore connected to one another by being placed on or plugged into and rotated opposite each other, and can also be separated from one another in reverse order if required. By the placing on or plugging in and subsequent rotational movement, a fluidic and mechanical coupling of the adapter to the sealing liquid container or the second fluid coupling section of the adapter with the air inlet opening of the sealing liquid container occurs. It is therefore easy to manufacture and operationally reliable.

It can also be provided that the second fastening section has at least one locking element which is configured to engage in the at least one second recess during the rotational movement of the sealing liquid container in the first direction of rotation and, after the engagement, to block a rotational movement of the sealing liquid container relative to the adapter in a second direction of rotation opposite to the first direction of rotation. In particular, the locking element can be designed as a hook. The locking element can block the desired end position of the bayonet lock against unintentional releasing in order to increase the operational safety when the device is used.

Furthermore, it can be provided that the adapter has at least one stop which is configured to block a rotational movement of the sealing liquid container in a second direction of rotation opposite the first direction of rotation relative to the adapter. The at least one stop can be designed as an elevation of an edge section of a main body of the adapter. The at least one stop then abuts against a wall or rib of the sealing liquid container when an attempt is made to unintentionally release the coupling or the bayonet lock of the adapter with the sealing liquid container after the coupling or the bayonet lock has been established. The coupling or the bayonet lock between the adapter and the sealing liquid container can thereby already performed in the factory since the adapter can be produced comparatively compactly so that the space requirement of the system consisting of adapter and sealing liquid container is only slightly greater than the sealing liquid container by itself. The sealing liquid container can therefore be used more quickly.

Furthermore, it can be provided that adapters are designed as a main body with an edge section and an inner section connected to the edge section and surrounded by the edge section. In this case, the edge section can be designed as a standing part of the base, and the inner section can have the first fluid coupling section and the second fluid coupling section. The edge section and the inner section can be connected to one another by means of at least one web. The at least one web ensures the provision of the fluid coupling sections and the base functionality of the adapter in only one component. A particularly lightweight adapter can thereby be provided by means of the at least one web. The adapter can be produced in one piece.

In particular, it can be provided that the edge section is formed by a cylindrical outer wall. The outer wall can completely surround the inner section and provide the sealing liquid container with a secure footing as a wall standing on the surface.

In this case, it can be provided that the outer wall has a recess for conducting an air hose from the first fluid coupling section through the outer wall to fluidically couple the first fluid coupling section to the compressor. This enables the connection of the first fluid coupling section to the compressor, which can be produced in a simple manner, with simultaneous functionality of the outer wall as a standing part and therefore of the adapter as a base. The safe state of the sealing liquid container is thereby not influenced by the air hose.

In addition, it can be provided that the adapter has a storage compartment which is formed between the edge section and the inner section and is configured to store an air hose. This allows the air hose in the adapter to be stowed conveniently when the device is not in operation. The device can therefore be kept particularly compact in the non-used or non-assembled state.

In this case, it can be provided that the adapter has a first securing section for securing the air hose received in the storage compartment and is formed on the edge section. The first securing section can be arranged circumferentially or along the edge section. The securing section secures the air hose within the storage compartment and prevents the air hose from inadvertently coming out of the storage compartment. The system can therefore always be compactly placed in compartments within the motor vehicle provided for the system consisting of the adapter, air hose, and sealing liquid container.

In addition, it can be provided that the first securing section has multiple first securing elements projecting from the edge section of the adapter in the direction of the inner section of the adapter. In particular, the first securing section can be formed by the first securing elements. The first securing elements allow the air hose to be secured in the storage compartment while simultaneously allowing easy stowage, since there is space between the first securing elements. The first securing elements can accordingly be arranged at a distance from one another, for example equidistantly from one another, at the edge section.

Finally, it can be provided that the inner section has a second securing section which is configured to secure a first fluid coupling end piece of the air hose stowed in the storage compartment and/or the inner section has a third securing section which is configured to secure a second fluid coupling end piece of the air hose stowed in the storage compartment. The second securing section can, for example, be designed as a recess in one of the at least one web into which the first fluid coupling end piece is inserted in a form-fitting manner and thereby held. The third securing section can, for example, be formed by inner walls of the adapter, between which the second fluid coupling end piece is accommodated in a form-fitting manner within the storage compartment. The fluid coupling end pieces can therefore also be secured in the storage compartment in a simple manner.

The object mentioned at the outset is, on the other hand, achieved by a system consisting of the adapter and the sealing liquid container. In this case, the second fluid coupling section is fluidically coupled to the air inlet opening of the sealing liquid container.

It can be provided that the second fastening section is fastened to the third fastening section of the sealing liquid container by the rotational movement of the sealing liquid container in the first direction of rotation relative to the adapter.

Furthermore, it can be provided that the at least one first fastening element engages in the at least one first recess of the sealing liquid container with the help of the placement movement of the sealing liquid container on the adapter, and is brought into engagement with the at least one second recess of the third fastening section by the rotational movement of the sealing liquid container in the first direction of rotation.

In addition, it can be provided that the at least one locking element engages in the at least one second recess and blocks the rotational movement of the sealing liquid container relative to the adapter in the second direction of rotation.

Furthermore, it can be provided that the at least one stop rests against the sealing liquid container, and the rotational movement of the sealing liquid container in the second direction of rotation is blocked relative to the adapter.

It can, of course, also be provided that the system further comprises the air hose. The air hose can be stowed in the storage compartment. In addition, the air hose can be secured in the storage compartment by the first securing section.

Finally, it can also be provided that the first fluid coupling end piece is secured by the second securing section and/or the second fluid coupling end piece by the third securing section in the storage compartment.

The object mentioned at the outset is also achieved by a device for sealing pneumatic tires by means of a sealing liquid. The device has the system, the compressor, and an air hose. The system and the compressor cannot be assembled using the air hose or cannot be coupled to one another, or are assembled or coupled to one another. In this case, the first fluid coupling section can be fluidically coupled to the compressor by means of the air hose.

The assembled state of the device, which can alternatively also be referred to as a kit for sealing pneumatic tires by means of a sealing liquid, in which kit the compressor and the adapter of the sealing liquid container are fluidically coupled to one another by means of the air hose, is simple to produce and enables operationally reliable sealing of a damaged pneumatic tire by means of the sealing liquid in the sealing liquid container, as described at the outset with regard to the functional principle thereof.

A possible exemplary embodiment of the invention, which can be taken from the aforementioned and further features, also results from the following drawings and the description in this respect. This exemplary embodiment is explained in more detail below. In the drawings:

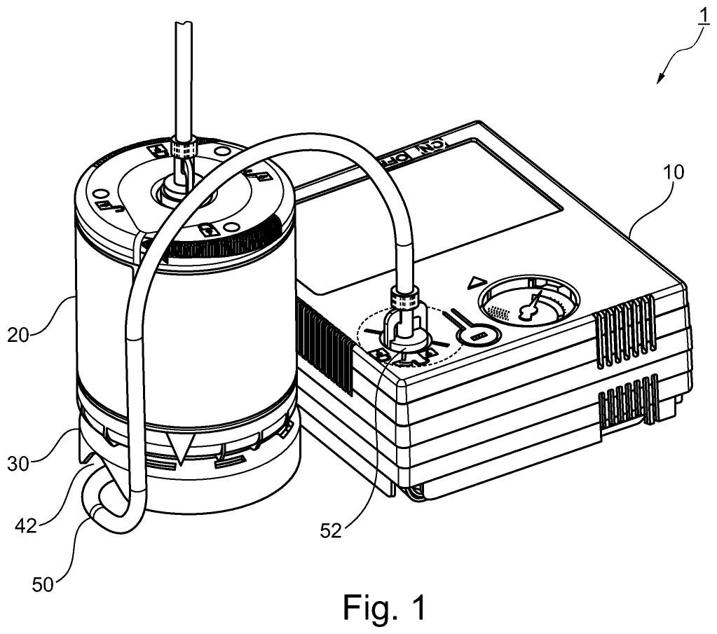

FIG. 1 shows a device for sealing pneumatic tires by means of a sealing liquid in an assembled state;

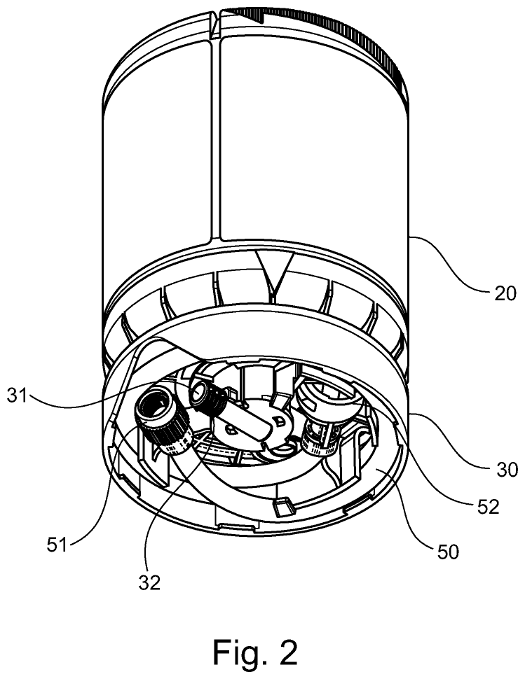

FIG. 2 shows the system of the device of FIG. 1, which comprises an adapter, a sealing liquid container, and an air hose;

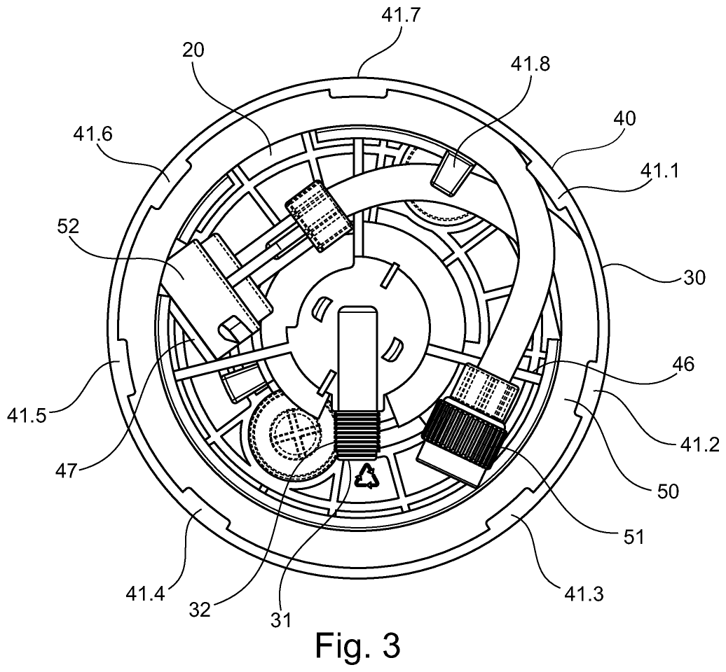

FIG. 3 shows a bottom view of the system from FIG. 2;

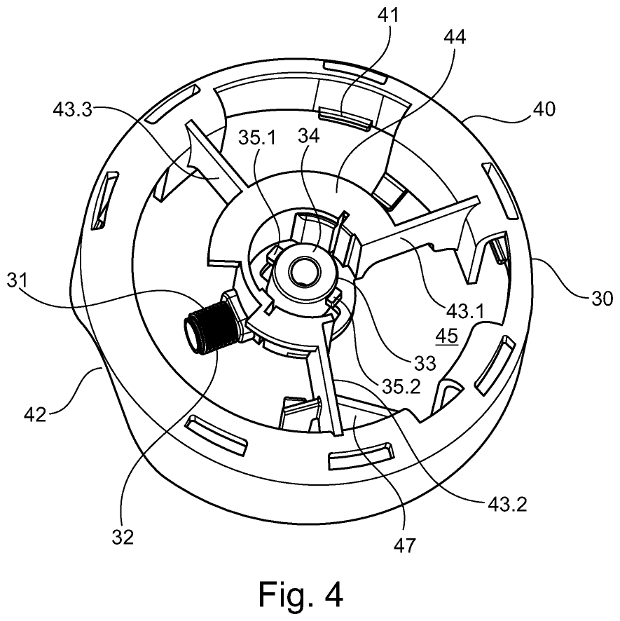

FIG. 4 shows the adapter of the system from FIGS. 2 and 3;

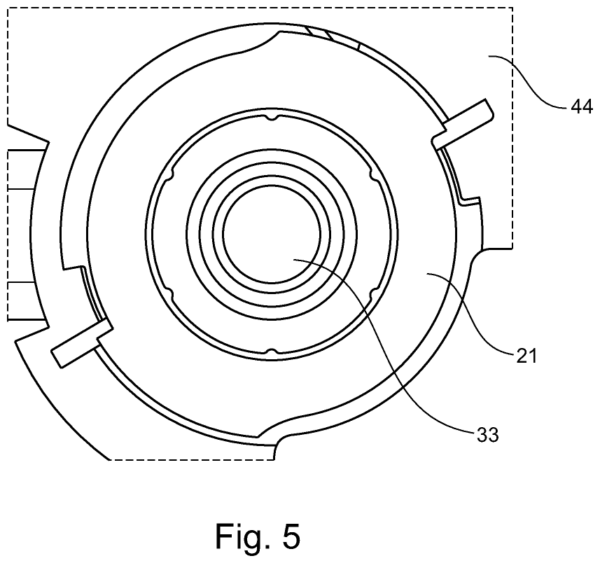

FIG. 5 shows a coupling between the adapter and the sealing liquid container;

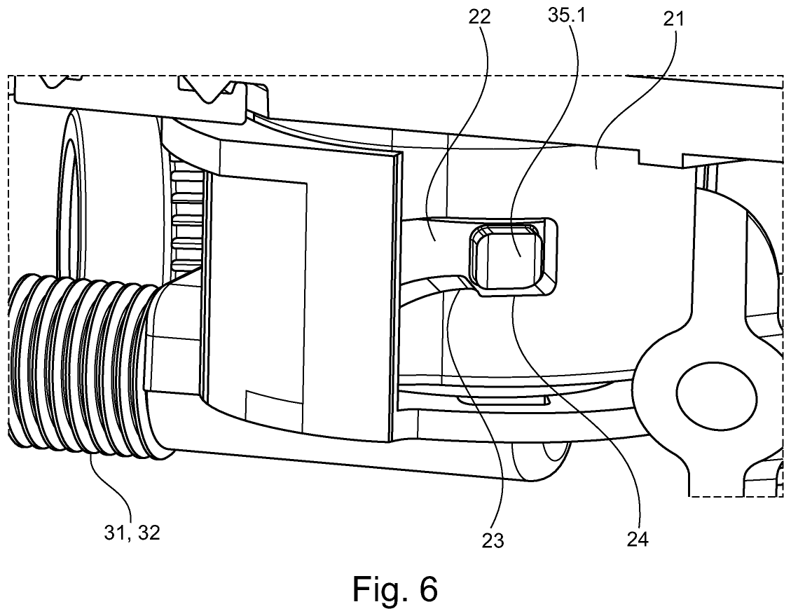

FIG. 6 shows a perspective view of the coupling; and

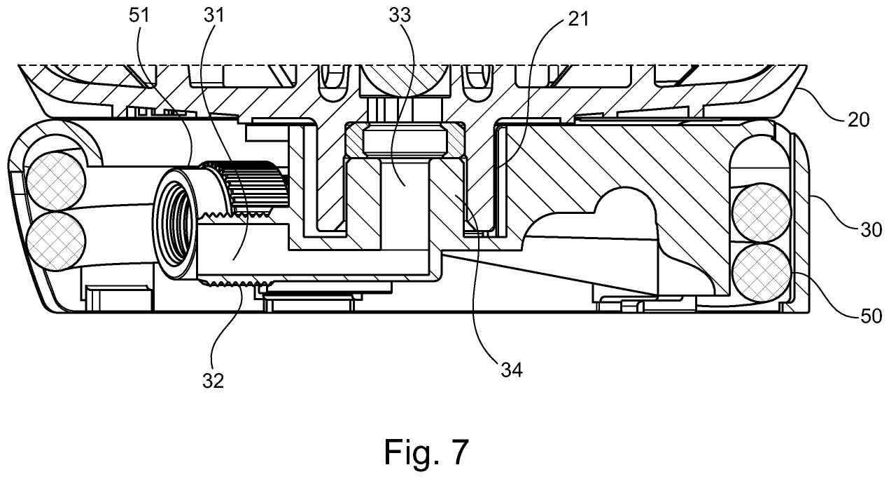

FIG. 7 shows a sectional view through the system from FIGS. 2 and 3.

Identical elements in FIGS. 1 to 7 are denoted by the same reference signs. If identical elements are present and visible more than once in one of FIGS. 1 to 7, the elements are additionally numbered consecutively, with the consecutive numbering being separated by a point from the reference sign.

FIG. 1 shows a device 1 for sealing pneumatic damaged tires by means of a sealing liquid. The sealing liquid is contained in a sealing liquid container 20 of the device 1. The sealing liquid container 20 is fluidically coupled to a compressor 10 of the device 1 by means of an adapter 30 and an air hose 50. Furthermore, another tube is shown on the upper side of the sealing liquid container 20 which, during operation of the device 1, is guided to the damaged pneumatic tire in order to apply the sealing liquid there from the compressor 10 by means of the compressed air, as has already been explained at the outset as a functional principle of such a comfort system.

The adapter 30 does not only function as a fluidical coupling element between the sealing liquid container 20 and the compressor 10, but also as a base of the sealing liquid container 20. The sealing liquid container 20 is placed on the adapter 30 which in turn stands on the surface free of the compressor 10. As a result, the sealing liquid container 20 is also stands on the surface free of the compressor 10.

As can also be seen in FIG. 1, the air hose 50 is conducted through a recess 42 in the adapter 30 between the adapter 30, in particular otherwise closed off from the surface, and past the surface to the compressor 10.

FIG. 2 shows a bottom view of a system of the device 1 formed from the sealing liquid container 20, the adapter 30 and the air hose 50. This compact system can easily be stowed in a motor vehicle and is quickly and easily ready for connection to the compressor 10, which is also stowed in the motor vehicle, when a pneumatic tire has been damaged needs to be kept roadworthy for a limited time of travel.

As FIG. 2 shows, the air hose 50 has two fluid coupling end pieces 51, 52. As can be seen from FIG. 1, the second fluid coupling end piece 52 is coupled securely and fluid-tight to the compressor 10. The first fluid coupling end piece 51, in contrast, serves for a secure and fluid-tight connection to the adapter 30. For this purpose, the adapter 30 has a first fluid coupling section 31 corresponding to the first fluid coupling end piece 51. This is designed in the form of a tube. The first fluid coupling section 31 also has a first fastening section 32 for mechanically fastening the first fluid coupling end piece 31 thereto. In the present case, the first fastening section 32 is formed by an external thread 32 of the first fluid coupling section 31 designed as a tube.

FIG. 3 illustrates the design of adapter 30 and air hose 50 in the system assembly in a bottom view of the system. It can be seen here that the air hose 50 is stowed within a storage compartment 45 (see FIG. 4) formed by the adapter 30. A first securing section in the form of multiple first securing elements 41.1, 41.2, 41.3, 41.4, 41.5, 41.6, 41.7, 41.8, which project from an edge section 40 of the adapter 30 to a center of the adapter 30, secure the air hose 50 within the storage compartment 45.

Furthermore, the first fluid coupling end piece 51 is secured by means of a second securing section 46 of the adapter 30, in the present case in the form of a recess in a web 43 (see FIG. 4), which recess corresponds to the first fluid coupling end piece 51 in a form-fitting manner. The second fluid coupling end piece 52 is secured in a form-fitting manner in the adapter 30 by means of a third securing section 47 of the adapter 30, in the present case in the form of multiple inner walls of the adapter 30.

FIG. 4 shows the adapter 30 without the air hose 50. It can be seen that the adapter 30 substantially consists of an edge section and an inner section 44. The adapter 30 has a cylindrical main body which is formed by the cylindrical edge section 40. The inner section 44 and the edge section 40 are connected to one another by means of webs 43.1, 43.2, 43.3.

A second fluid coupling section 33 of the adapter 30, to be precise the inner section 44, which is fluidly coupled to the first fluid coupling section 31, is configured to fluidically couple the adapter 30 to an air inlet opening of the sealing liquid container 20 of the device 1. Furthermore, the second fluid coupling section 33 has a second fastening section 34 for mechanically coupling to the sealing liquid container 20. The second fastening section 34 has two first fastening elements 35.1, 35.2 which protrude from the second fastening section 34 in the opposite direction.

As can be seen from FIGS. 5 and 6, the second fastening section 34 is coupled to the third fastening section 21 of the adapter 30 by a push-on movement of the sealing liquid container 20 onto the adapter 30 and a subsequent rotational movement, wherein the second fluid coupling section 33 is fluidically connected to the air inlet opening of the sealing liquid container 20. The coupling accordingly takes place in the form of a bayonet lock, in which the first fastening elements 35.1, 35.2, by the insertion movement, pass into corresponding first recesses (not shown) of the third fastening section 21. As a result, they reach second recesses 22 (see FIG. 6) of the third fastening section 21, which are designed as elongated holes and run obliquely to the first recesses in the circumferential direction of the third fastening section 21. As a result of the rotational movement, the bayonet lock is produced in that the first fastening elements 35.1, 35.2 slide over ramps 23 of the second recesses 22 and reach end sections 24 of the second recesses 22, which are separated from the ramps 23 by steps (not designated), in which they are fixed.

FIG. 7 again shows the system consisting of sealing liquid container 20, adapter 30, and air hose 50. The design of the connection between the first fluid coupling section 31 and the second fluid coupling section 33, which are arranged at a right angle to one another, can be seen particularly well here. The fluid coupling sections 31, 33 of the adapter 30 are tubular.

1. An adapter (30) for a device (1) for sealing pneumatic tires by means of a sealing liquid, wherein the adapter (30) has a first fluid coupling section (31) which is configured for fluidically coupling the adapter (30) to a compressor (10) of the device (1), and wherein the adapter (30) has a second fluid coupling section (33) which is fluidically coupled to the first fluid coupling section (31) and is configured to fluidically couple the adapter (30) to an air inlet opening of a sealing liquid container (20) of the device (1), characterized in that the adapter (30) is designed as a base for the sealing liquid container (20).

2. The adapter (30) according to claim 1, wherein the first fluid coupling section (31) has a first fastening section (32) which is configured to fasten an air hose (50) for fluidically coupling the adapter (30) to the compressor (10).

3. The adapter (30) according to claim 1, wherein a second fastening section (34) is arranged on the second fluid coupling section (31) and is configured to fasten the sealing liquid container (20) to the adapter (30).

4. The adapter (30) according to claim 3, wherein the second fastening section (34) is configured to be coupled by a rotational movement of the sealing liquid container (20) in a first direction of rotation relative to the adapter (30) with a third fastening section (21) of the sealing liquid container (20).

5. The adapter (30) according to claim 4, wherein the second fastening section (34) has at least one first fastening element (35) which is configured to engage in at least one first recess of the third fastening section (21) by a placement movement of the sealing liquid container (20) on the adapter (30) and to be brought into engagement with at least one second recess (22) of the third fastening section (21) by a rotational movement of the sealing liquid container (20) in the first direction of rotation.

6. The adapter (30) according to claim 1, wherein the adapter (30) is designed as a main body with an edge section (40) and an inner section (44) connected to the edge section (40) and surrounded by the edge section (40), wherein the edge section (40) is designed as a standing part of the base, and the inner section (44) has the first fluid coupling section (31) and the second fluid coupling section (33).

7. The adapter (30) according to claim 6, wherein the edge section (40) is formed by a cylindrical outer wall.

8. The adapter (30) according to claim 7, wherein the outer wall has a recess (42) for conducting an air hose (50) from the first fluid coupling section (31) through the outer wall to fluidically couple the first fluid coupling section (31) to the compressor (10).

9. The adapter (30) according to claim 8, wherein the first fluid coupling section (31) is designed as a tube which is oriented toward the recess (42).

10. The adapter (30) according to claim 6, wherein the adapter (30) has a storage compartment (45) which is formed between the edge section (40) and the inner section (44) and is configured to store an air hose (50).

11. The adapter (30) according to claim 10, wherein the adapter (30) has a first securing section for securing the air hose (50) received in the storage compartment (45) and is formed on the edge section (40).

12. The adapter (30) according to claim 11, wherein the first securing section has multiple first securing elements (41) projecting from the edge section (40) of the adapter (30) in the direction of the inner section (44) of the adapter (30).

13. The adapter (30) according to claim 10, wherein the inner section (44) has a second securing section (46) which is configured to secure a first fluid coupling end piece (51) of the air hose (50) stowed in the storage compartment (45), and/or the inner section (44) has a third securing section (47) which is configured to secure a second fluid coupling end piece (52) of the air hose (50) stowed in the storage compartment (45).

14. A system consisting of an adapter (30) according to claim 1 and the sealing liquid container (20), wherein the second fluid coupling section (33) is fluidically coupled to the air inlet opening of the sealing liquid container (20).

15. The system according to claim 14, wherein the adapter (30) is designed according to claim 4, and the second fastening section (34) is fastened to the third fastening section (21) of the sealing liquid container (20) by the rotational movement of the sealing liquid container (20) in the first direction of rotation relative to the adapter (30).

16. The system according to claim 14, wherein the at least one first fastening element (35) engages in the at least one first recess of the sealing liquid container (20) with the help of the placement movement of the sealing liquid container (20) on the adapter (30), and is brought into engagement with the at least one second recess (22) of the third fastening section (21) by the rotational movement of the sealing liquid container (20) in the first direction of rotation.

17. The system according to claim 14, wherein the system further comprises the air hose (50) that is stowed in the storage compartment (45).

18. The system according to claim 16, wherein the air hose (50) is secured by the first securing section in the storage compartment (45).

19. The system according to claim 17, wherein the first fluid coupling end piece (51) is secured by the second securing section (46) and/or the second fluid coupling end piece (52) by the third securing section (47) in the storage compartment (45).

20. A device (1) for sealing pneumatic tires by a sealing liquid, wherein the device (1) comprises a system according to claim 14, the compressor (10) and an air hose (50).
